(19) United States
(12) Patent Application Publication
(10) Pub. No.: US 2006/0064762 A1
(43) Pub. Date: Mar. 23, 2006

(54) System and method for managing expiration date for use of contents in removable media

(76) Inventors: Makoto Kayashima, Yokohama (JP); Mariko Kasai, Ebina (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/169,772

(22) Filed: Jun. 30, 2005

(30) Foreign Application Priority Data
Sep. 15, 2004 (JP) 2004-268519

(51) Int. Cl. H04L 9/32

(52) U.S. Cl. 726/27; 713/194

(57) ABSTRACT

A system for managing expiration date for use of contents, including: a computer having a CPU, a memory for storing programs, a clock device, a network I/O, and a removable media I/O; and a removable medium having a memory for storing a content sand last access time information indicating the last time of access to the contents, and a controller as a tamper-resistant module, access limit information being added to the contents, the contents being encrypted and stored, wherein: current time information is acquired from the clock device; the acquired current time is compared with the last access time on the memory of the removable medium to thereby control the contents on the removable medium in accordance with the expiration date as to whether the contents are enabled to be used, so that illegal access of the contents due to backdating of the clock device can be prohibited.

### INCORPORATION BY REFERENCE

This application claims priority based on a Japanese patent application No. 2004-268519, filed on Sep. 15, 2004, the entire contents of which are incorporated herein by reference.

### BACKGROUND OF THE INVENTION

The present invention relates to a system and method for managing an expiration date for use of contents stored in a removable medium and particularly to a technique for preventing illegal access to contents from being made due to backdating time information.

For example, a method as described in JP-A 2001-202493 has been heretofore known as a method for controlling an expiration date for use of contents stored in a removable medium. This method is provided so that functions of applications mounted in the removable medium can be limited/added in accordance with the expiration date for use.

Unforged correct time information is required for confirming that the expiration date for use of the contents has been already reached. For example, a method as described in JP-A 2003-208406 has been known as a method for preventing falsification of time information provided by a computer in the case where the computer using the contents is off-line.

### SUMMARY OF THE INVENTION

In the method described in JP-A 2001-202493, the contents stored in the removable medium (IC card) are provided so that functions can be limited/added in accordance with the expiration date for use on the basis of time information acquired from the outside. For this reason, the computer using the removable medium can work on the assumption that the computer is connected to a network provided with a server for providing the current time. That is, there is no consideration for off-line use of the computer.

To make it possible to limit/add functions in accordance with the expiration date for use when the computer is off-line (i.e. the computer is not connected to the network provided with the server for providing the current time), it is important that accurate time information is acquired. In the method described in JP-A 2003-208406, the expiration date for use of each content is managed on the basis of the start time of the validated term and the end time of the validated term, and the time to be referred to at the time of authentication is updated on the basis of the start time of the validated term of the contents to be used so that the contents can be prevented from being used illegally due to backdating of the time (disordering the timepiece function to retrace the time). When only one contents is used continuously, the time to be referred to at the time of authentication cannot be updated. It is therefore preferable that illegal use of the content can be prevented from being made due to backdating of the time.

Upon such circumstances, the invention prevents illegal access to contents by controlling enabling/disabling of use in accordance with an expiration date for use with respect to contents kept on a removable medium in a computer used as a mobile computer regardless of whether the computer is connected to a network or not.

To solve the problem, the invention mainly uses the following configuration.

A system for managing an expiration date for use of contents, including: a computer including a CPU, a memory for storing programs inclusive of OS, a clock device, a network I/O module, and a removable media I/O module; and a removable medium including a memory for storing at least one contents file provided with access limit information, encrypted, written and browsed and last access time information of last access to the contents file, and a controller as a tamper-resistant module, wherein: current time information is acquired from the clock device; and illegal browsing of the contents due to backdating of the clock device is prohibited on the basis of comparison between the acquired current time information and the last access time information stored in the memory of the removable medium.

A system for managing an expiration date for use of contents, including: a computer including a CPU, a memory for storing programs inclusive of OS, a clock device, and a removable media I/O module; and a removable medium including a memory for storing at least one contents file and last access time information of last access to the contents file, and a controller as a tamper-resistant module, wherein: a process of writing contents in the removable medium by a editor program stored in the memory of the computer is carried out in such a manner that the contents are encrypted, provided with access limit information and stored in the memory of the removable medium, and current time is acquired from the clock device or from an NTP server through a network and written as the last access time information in the user-unreferenced form in the memory of the removable medium; and a process of browsing the contents by a viewer program stored in the memory of the computer is carried out in such a manner that current time is acquired from the clock device or from an NTP server through a network, the fact that the acquired current time is unforged is confirmed by comparison between the acquired current time and the last access time on the basis of the acquired current time information, the contents access limit information and the written last access time information, and access to the contents is enabled when the current time is within the access limit.

According to the invention, when contents stored in the removable medium are referred to regardless of whether the computer is on-line or off-line, the contents can be controlled so that access to the contents is disabled when the expiration date given to the contents is over.

In addition, illegal use of the contents due to backdating of the time can be made difficult in enabling/disabling of use in accordance with the expiration date given to the contents.

These and other benefits are described throughout the present specification. A further understanding of the nature and advantages of the invention may be realized by reference to the remaining portions of the specification and the attached drawings.

### BRIEF DESCRIPTION OF THE DRAWINGS

FIG. 1 is a view showing the overall associative configuration of the system for managing expiration date for use of contents in removable media according to this embodiment.

FIG. 2 is a diagram showing the internal configuration of a combination of a computer and a removable medium constituting the system for managing expiration date for use of contents according to this embodiment.

FIG. 3 is a diagram showing the internal configuration of an NTP (Network Time Protocol) server used in the system for managing expiration date for use of contents according to this embodiment.

FIG. 4 is a flow chart showing a file generating process executed by a editor program in the system for managing expiration date for use of contents according to this embodiment.

FIG. 5 is a flow chart showing a file browsing process executed by a viewer program in the system for managing expiration date for use of contents according to this embodiment.

FIG. 6 is a view showing a mechanism of prohibiting falsification of time in the system for managing expiration date for use of contents in the removable medium according to this embodiment.

FIG. 7 is a view showing the format of the contents file and the format of the last access time information in the removable medium in this embodiment.

### DETAILED DESCRIPTION OF THE EMBODIMENTS

A system for managing expiration date for use of contents according to an embodiment of the invention will be described below with reference to the drawings.

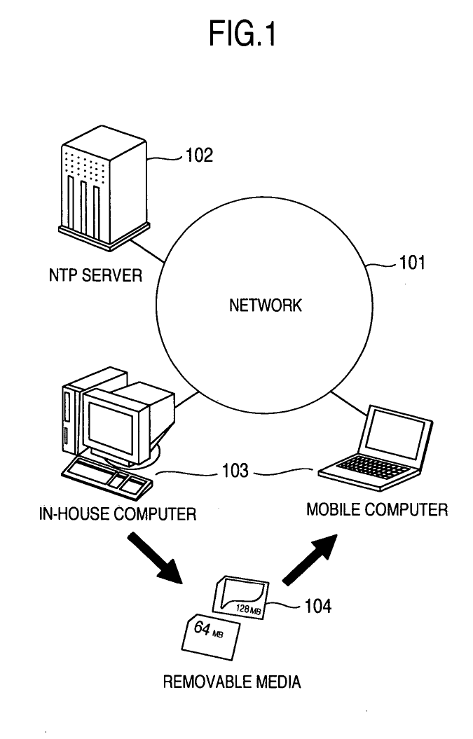

FIG. 1 is a view showing the overall associative configuration of the system for managing expiration date for use of contents in removable media according to this embodiment. In FIG. 1, the reference numeral 101 designates a network; 102, an NTP (Network Time Protocol) server for providing accurate time information; 103, computers used as in-house computers or mobile computers; and 104, removable media used to be inserted in the computers 103 and having storage areas protected by a tamper-resistant function (a function of preventing confidential data from being read by an illegal method).

In this embodiment, the removable media 104 are used as follows. The removable media 104 are inserted in a computer 103. Files generated in this condition are stored in the removable media and brought out of the organization. The removable media 104 are inserted in a mobile computer 103 so that the files in the removable media are browsed. The mobile computer 103 is provided on the assumption that a notebook computer possessed by an organization is used after brought out of the organization or on the assumption that a computer possessed by another organization is used. In a mode different from the mode used in this embodiment, the removable media 104 may be used in delivery of contents such as multimedia.

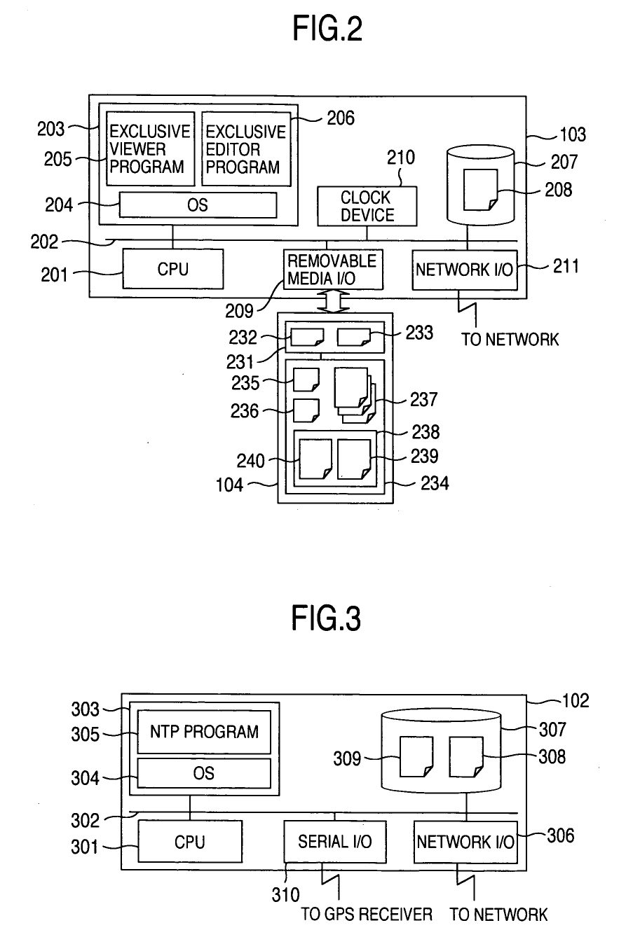

FIG. 2 is a diagram showing the internal configuration of a combination of a computer and a removable medium constituting the system for managing expiration date for use of contents according to this embodiment. The internal configuration of the combination of the computer 103 and the removable media 104 used in this embodiment will be described with reference to FIG. 2. The computer 103 has a CPU 201, and a bus 202 connected to the CPU. A memory 203, an external storage device 207, a removable media I/O module 209, a clock device 210 and a network I/O module 211 are connected to the bus 202. An operating system 204 is loaded on the memory 203. An executive viewer program 205 and an executive editor program 206 run on the operating system 204. A loader module 208 for loading the operating system is stored in the external storage device 207.

The removable medium 104 has a controller 231 achieved as a tamper-resistant module, and a flash memory 234 which is rewritable and nonvolatile. An encryption key 232 used in a common-key encryption method and a private key 233 (not open to the public) used in a public-key encryption method are stored in the controller 231.

A load module 235 corresponding to the executive viewer program 205 operating on the operating system 204, a load module 236 corresponding to the executive editor program 206 and an encrypted contents file group 237 are stored in the flash memory 234. There is also a protected area 238 in the flash memory 234. The last time of access to the removable medium 104 for use of the executive viewer program 205 and the executive editor program 206 is stored as last access time information 239 in the protected area 238. A password file 240 for authenticating a user who is allowed to operate the executive viewer program 205 and the executive editor program 206 is also stored in the protected area 238. Information concerned with accessible terms is written in the contents file group 237.

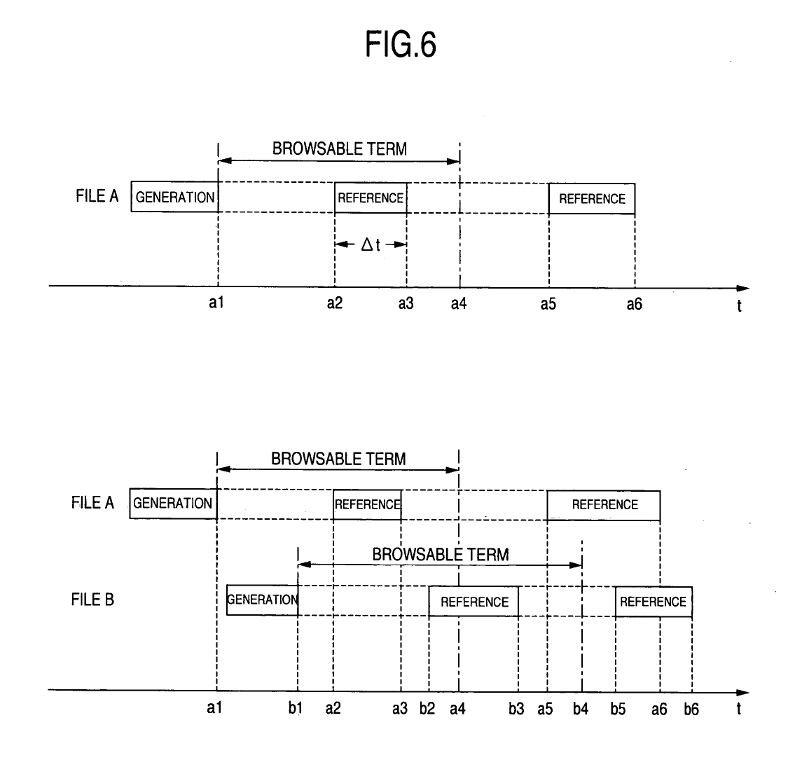

The executive viewer program 205 acquires current time from the NTP server 102 or from the clock device 210 in the computer 103 and judges whether contents can be browsed or not. Particularly for an operation of backdating the clock device 210, a process using the last access time information 239 is carried out in accordance with a flow chart (which will be described later) to make it difficult to use the contents illegally. In other words, as will be described later in detail in FIG. 6, browsing is substantially denied at the point of time when the accessible term is over. For an operation of intentionally backdating the current time of browsing to make browsing possible for illegal use of contents (by tracing the time back to a time point within the accessible term), illegal use of contents is prevented due to backdating by checking whether the last access time information of access to the file is before the backdated time or not.

Access to the protected area 238 is controlled by the controller 231 so that even the user of the removable medium 104 can neither refer to nor change the contents of the protected area 238. When the user cannot present a set PIN (Personal Identification Number), access is disabled. For example, this can be achieved by use of a mechanism of SMMC (Secure Multimedia Card) or the like. With respect to the encryption key 232 used in a common-key encryption method and stored in the controller 231, a key common to all removable media 104 may be used as the encryption key 232 because the encryption key 232 is stored in the controller 231 having tamper-resistant characteristic. Or different keys in accordance with removable media may be used as the encryption key 232.

FIG. 3 is a diagram for explaining the configuration of the NTP server 102 used in this embodiment. The NTP server 102 has a CPU 301, and a bus 302 connected to the CPU. A memory 303, a network I/O module 306 and an external storage device 307 are connected to the bus 302. An operating system 304 is loaded on the memory 303. An NTP server program 305 runs on the operating system 304. Although a method of inquiring of a higher NTP server about the time via a network may be used to make the NTP server program acquire correct time information, a receiver of a GPS (Global Positioning System) connected to a serial I/O module 310 of the NTP server 102 may be used to acquire correct time information more safely.

A load module 308 for the operating system is also stored in the external storage device 307. An authentication function is added in order to warrant the genuineness of the NTP server 102. For example, an operating system into which an IPsec (IP security protocol) function is integrated can be used for this authentication function. On this occasion, authentication information 309 for performing authentication due to IPsec is stored in the external storage device 307. Or an SSL (Secure Sockets Layer) server may be operated on the NTP server 102 so that an inquiry of the NTP server 102 about the time can be made via the SSL server.

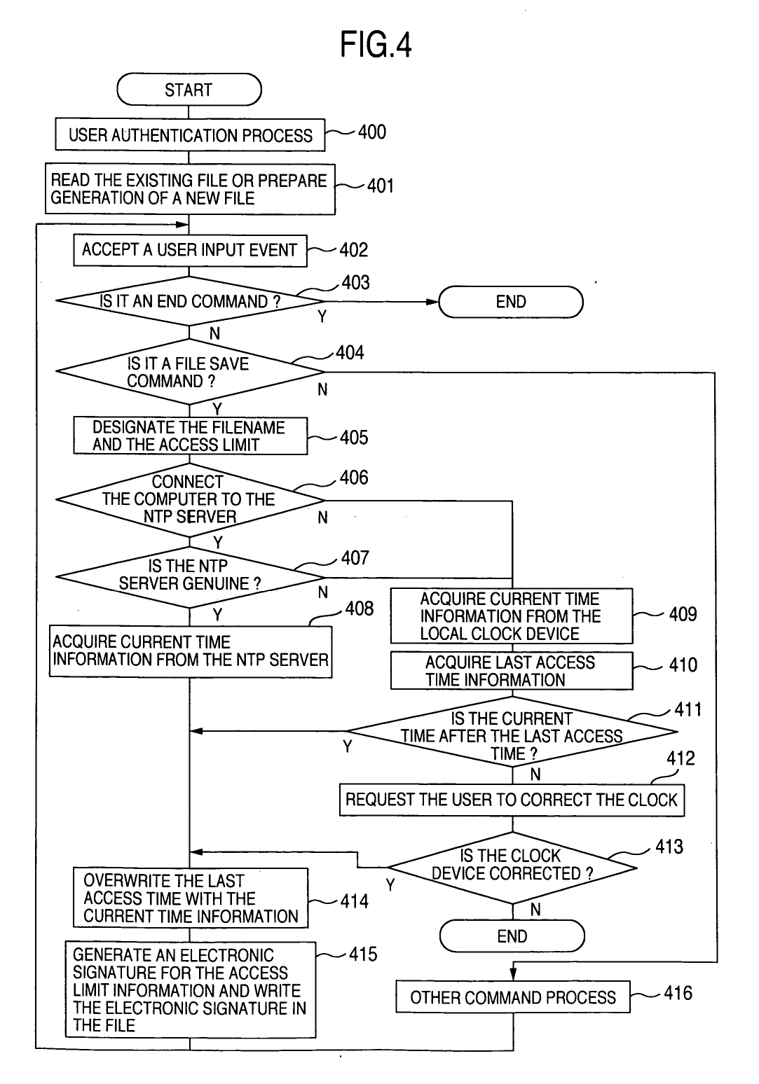

FIG. 4 is a flow chart showing a process of generating the contents file group 237 stored in the removable medium 104 by using the executive editor program 206 running on the computer 103, in the system for managing expiration date for use of contents according to this embodiment. Step 400 is a step of authenticating the user of the executive editor program 206 by using the password file 240 in the removable medium 104. Step 401 is a step of preparing editing of contents in such a manner that the existing contents file 237 stored in the removable medium 104 inserted in the computer 103 is read into the executive editor program 206 or a new contents file is opened. Steps 402 to 416 form a main loop in this program. The step 402 is a step of accepting various kinds of events input by the user. The step 403 is a step of judging whether the accepted user input event is a termination command or not. When the event is a termination command, the program is terminated.

The step 404 is a step of judging whether the accepted user input event is a file save command or not. If the event is a file save command, steps 405 to 415 are executed. Otherwise, step 416 is executed. The step 405 is a step of requesting the user to input the filename of the contents to be saved and the access limit of the contents. The step 406 is a step of connecting the computer 103 to the NTP server 102 on the basis of the identifier (e.g. IP address and port number) of the NTP program 305 which is registered in the executive editor program 206 in advance. The step 407 is a step of authorizing the NTP program to detect a fake.

The step 408 is a step executed when the computer is connected to the correct NTP server. That is, the step 408 is a step of acquiring correct current time by inquiring of the NTP program 305. Steps 409 to 413 are a process carried out when connection to the NTP server 102 results in failure or when authentication of the NTP server 102 results in failure. The step 409 is a step of acquiring current time by referring to the clock device 210 included in the computer 103. The step 410 is a step of acquiring last access time information 239 stored in the protected area 238 (the data area protected so that data cannot be read by the user) of the removable medium 104. The step 411 is a step of comparing the current time information acquired from the local clock device by the step 409 with the last access time information acquired by the step 410 to thereby check whether the current time information acquired from the local clock device is backdated or not.

The steps 412 and 413 are a process carried out when the current time information is backdated. The step 412 is a step of requesting the user of the executive editor program 206 to correct the clock of the computer 103 (because the time of the clock device may be wrong for the reason of an accident other than the illegal backdating of the clock device). The step 413 is a step of checking whether the clock is corrected or not. When the clock is not corrected, the program is terminated.

Step 414 and steps after the step 414 are a process carried out when correct current time information is acquired from the NTP server 102 or from the local clock device 210. The step 414 is a step of overwriting the last access time information 239 in the protected area 238 of the removable medium 104 with the acquired current time information (so that the last access time is updated and stored in some file, that is, the last time of access to the removable medium is stored). The step 415 is a step of writing the contents as a contents file 237 in the removable medium 104 after encrypting the contents by using the encryption key 232, adding the access limit information acquired by the step 405 to the encrypted contents and adding a digital signature to the encrypted contents by using the private key 233 to prevent the access limit information from being falsified by a third person.

In the executive editor program 206, it is important that the last access time information 239 (updated to the current time information) in the protected area of the removable medium 104 is kept correct. Therefore, the authentication information 309 of the NTP server 102 is used for performing server authentication to prevent illegal time information from being answered by a false NTP program in the step 406.

Moreover, when the executive editor program 206 makes access to the current time information 239 in the protected area 238 of the removable medium 104, the executive editor program 206 presents PIN to the controller 231 to prevent the current time information 239 from being rewritten freely by any other program than the executive editor program 206 or to prevent the encryption key 232 and the private key 233 from being used illegally. (The controller 231 can authenticate the executive editor program 206.) This may be achieved in such a manner that the executive editor program 206 and the controller 231 of the removable medium 104 authenticate each other. The step 413 of checking whether the clock is corrected or not, may be omitted so that the executive editor program 206 is terminated unconditionally when the clock is not correct.

In another embodiment than this embodiment, the load module 236 of the executive editor program 206 may be stored in the external storage device 207 of the computer. In this embodiment, the password file 240 stored in the removable medium 104 may be used or another password file may be provided in the external storage device 207 to execute an authorizing process at the time of starting the executive editor program.

Even in the case where the load module 236 of the executive editor program 206 stored in the removable medium 104 is used, the password file provided in the external storage device 207 may be used.

In the step 411 of checking whether the current time information acquired from the local clock device is backdated or not, the dates of various kinds of files stored in the external storage device 207 of the computer 103 may be confirmed so that the absence of files saved after the acquired current time (the absence of files dated after the current time) can be confirmed (by referring to the dates given to the files because dates are generally given to files (e.g. document files) stored in the external storage device by an ordinary operation).

Limitation on the number of times may be provided for the clock correcting request in the step 412. This may be achieved in such a manner that the number of times for correcting the clock and the time of correcting the clock are recorded in the protected area 238.

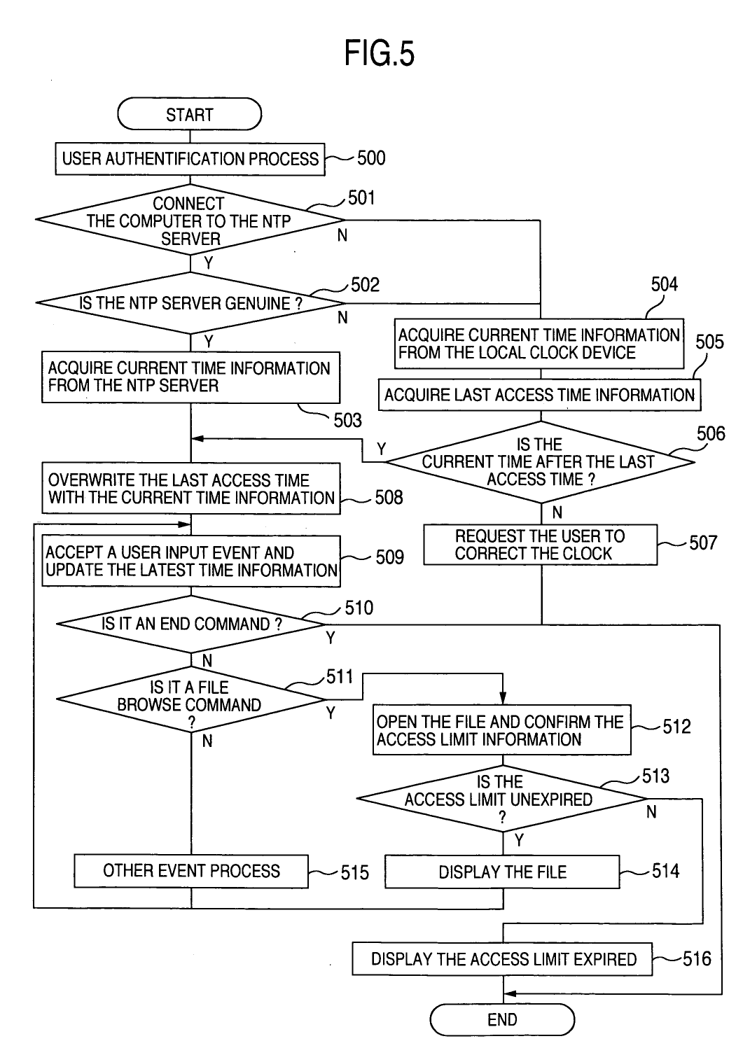

FIG. 5 is a flow chart showing a process for displaying the contents file group 237 stored in the removable medium 104 by using the executive viewer program 205 operating on the computer 103 in the system for managing expiration date for use of contents according to this embodiment. Step 500 is a step of authenticating the user of the executive viewer program 205 by using the password file 240 in the removable medium 104. Step 501 is a step of connecting the computer 103 to the NTP server 102 on the basis of the identifier (e.g. IP address and port number) of the NTP program 305 which is registered in the executive viewer program 205 in advance. Step 502 is a step of performing authentication to detect a false NTP program.

Step 503 is a step executed when the computer 103 can be connected to a true NTP server. That is, step 503 is a step of acquiring current time information by inquiring of the NTP program 305. Steps 504 to 507 are a process carried out when connection to the NTP server 102 results in failure or when authentication of the NTP server 102 results in failure. The step 504 is a step of acquiring current time information by referring to the clock device 210 included in the computer 103. The step 505 is a step of acquiring last access time information 239 stored in the protected area 238 of the removable medium 104. The step 506 is a step of comparing the current time information acquired by the step 504 with the last access time information acquired by the step 505 to thereby check whether the current time information is backdated or not. That is, when the current time information acquired from the clock device 210 is before the last access time information 239, the time of the clock device is regarded as being backdated.

The step 507 is a process executed when the current time information is backdated. After requesting the user of this program to correct the clock of the computer 103, this program is terminated. Step 508 and steps after the step 508 are a process executed when correct current time information is acquired from the NTP server 102 or from the local lock device 210. The step 508 is a step of overwriting the last access time information 239 in the protected area 238 of the removable medium 104 with the acquired current time information, preparing a memory for recording time in the program and recording the time. Steps 509 to 515 form a main loop of this program. The step 509 is a step of accepting a user input event, adding the lapsed time after execution of the step 508 to the last access time information 239 in the protected area 238 of the removable medium 104 and rewriting the last access time information 239 and the time recording memory in the program. The step 510 is a step of judging whether the accepted user event is an end command or not. When the user event is an end command, the program is terminated.

The step 511 is a step of judging whether the accepted user input event is a file browse command or not. When the user event is a file browse command, steps 512 to 514 are executed. When the user event is any other command than the file browse command, step 515 is executed. The step 512 is a step of opening the contents file 237 designated by the file browse command and confirming the access limit. The step 513 is a step of comparing the access limit acquired by the step 512 with the last access time information 239 at the current time point to thereby judge whether the current time point is within the access limit or not. When the current time point is within the access limit, the contents are decrypted by using the encryption key 232 in the step 514 and then the contents file is displayed. When the current time point is out of the access limit, a process of informing the user of the current time point being out of the access limit is executed in the step 516.

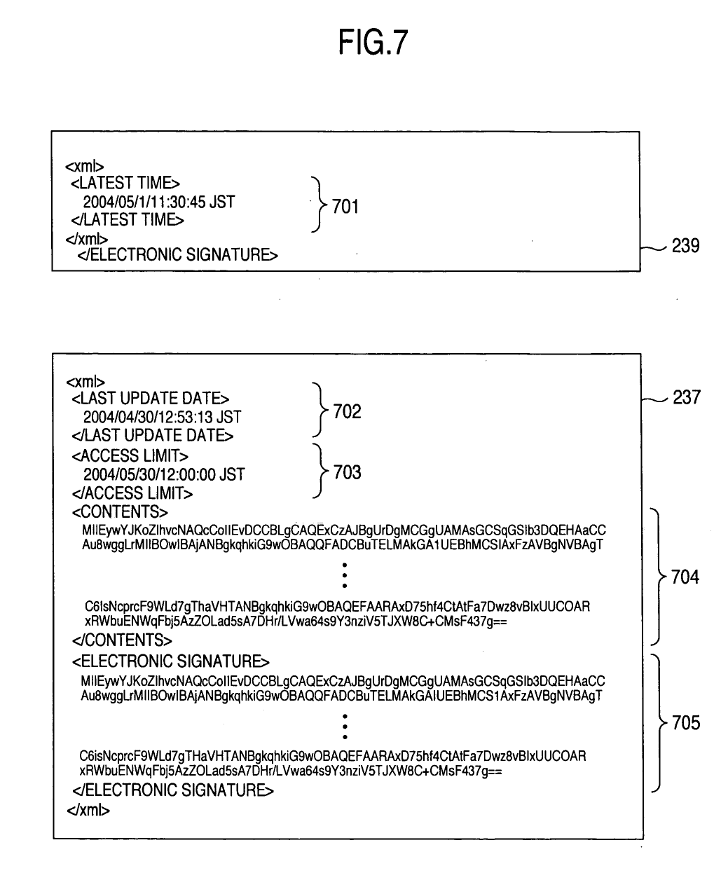

In the step 512, the digital signature added to the contents file 237 is confirmed to warrant the limit information (expiration date information) added to the contents file 237 (see lower half of FIG. 7).

When the executive viewer program 205 makes access to the current time information in the protected area 238 of the removable medium 104, the executive viewer program 205 and the controller 231 of the removable medium 104 authenticate each other to prevent the current time information 235 from being rewritten freely by any other program than the executive viewer program 205. Or the executive viewer program 205 may be controlled so that the executive viewer program 205 can make access only when the executive viewer program 205 is stored on the same removable medium.

The updating of the last access time information by the executive viewer program 205 may be performed by use of an interrupt timer or the like, independent of a user input command process.

Moreover, when an event of removal of the removable medium 104 from the computer 103 is detected, another event process may be executed so that the executive viewer program 205 deletes the contents file 237 read on the memory 203 on the computer 103. Moreover, user authentication in the step 500 can be dispensed with. Moreover, in the step 509, a judgment may be made as to whether currently browsed contents are within the access limit or not, in the same manner as in the step 513 so that browsing can be stopped when the access limit is over. In addition, limitation on the number of times may be provided for the clock correcting request in the step 507.

In another embodiment than this embodiment, the load module 235 of the executive viewer program 205 may be also stored in the external storage device 207 of the computer. The last access time information 239 may be encrypted by use of the encryption key 232. Moreover, display could be stopped when there is no last access time information 239 (because of deletion or the like).

When the access limit of the contents is expiring, the executive editor program 206 can be operated to save the contents afresh to thereby extend the limit. When the limit expires at the time of browsing the contents 237 by using the executive viewer program 205, the executive editor program 206 may be operated so that the limit can be extended after authentication of the legal user.

FIG. 6 is a view for explaining a mechanism of prohibiting falsification of time in this embodiment. The horizontal axis expresses time t. First, when a file generating person saves a file A in the removable medium 104 by using the executive editor program 206, the last access time information 239 is updated to a1. When the file generating person then begins to browse the file A by using the executive viewer program 205, a value (a3) obtained by adding the browsing term Δt to the current time a2 acquired from the NTP server 102 or from the clock device 210 of the computer 103 is written in the last access time information 239.

When the computer cannot be connected to the NTP server 102 at the time of starting the executive viewer program 205, the value a2 is acquired from the clock device of the computer 103. Accordingly, there is possibility that the value a2 is not accurate time. The last access time information 239 can be however updated by at least Δt from a1.

When the file A is to be browsed illegally at time a5 after the access limit a4, the clock device 210 of the computer 210 must be backdated to deceive the executive viewer program 205 because the accessible term expires (see upper half of FIG. 6) so that browsing is denied (ordinary operation) if the file A is browsed by use of the viewer program at time a5.

The content of the last access time information 239 can be however referred to by only the executive editor program 206 and the executive viewer program 205. Accordingly, the clock device 210 can hardly be backdated so that the current time a5 is adjusted to be not before a3 unless the start time (a2) of previous reference and the browsing term (Δt) are recorded so that the last access time (a3) can be recognized. That is, because an operating person to backdate the clock device 210 is not in a position to know the time a3, it is almost impossible to backdate the current time a5 to a point between a3 and a4. Unless the almost impossibility is changed to a possibility, it is impossible to browse the file A.

Particularly when a plurality of files are stored in the removable medium 104 and browsed, it is difficult to grasp the last access time information 239 (the last access time is the last time of access to the medium storing the files and is the last time of access to any one of the files) stored in the protected area 238, so that it is impossible to backdate the local clock device suitably (to adjust a5 to a point between a3 and a4 in the upper half of FIG. 6).

For example, referring to the lower half of FIG. 6, when the processes of (1) generation of a file A (time a1), (2) generation of a file B (time b1), (3) start of reference to the file A (time a2) and (4) end of reference to the file A (time a3) are carried out in time sequence, suitable backdating can hardly be performed as described above (the time after the last access time and within the accessible term) unless the access start time of the last access file and the browsing term can be found.

FIG. 7 is a view for explaining the format of the last access time information and the format of the contents file 237 in this embodiment. The last access time information 239 has a latest time storage field 701 for storing the value updated by the executive viewer program 205 and the executive editor program 206. Besides year, day, hour, minute and second, information concerned with time zone may be added to the description of time.

Because the last access time information 239 is stored in the protected area 238, there is no particular necessity of encryption and prevention of falsification. If the last access time information 239 is stored in a general area of a flash memory, encryption of the latest time storage field and prevention of falsification thereof may be achieved by use the encryption key 232 and the private key 233 (not open to the public) stored in the controller 231 and used in the common-key encryption method and in the public-key encryption method respectively. In addition, a digital signature field not shown may be provided in the same manner as the digital signature in the contents file which will be described later.

The contents file 237 has: a last update date field 702 (corresponding to time a1 in the upper half of FIG. 6) for storing the last update date in which the file was updated; a access limit field 703 for storing the access limit set by the executive editor program 206; a contents field 704 for storing the contents encrypted by the encryption key 232 used in the common-key encryption method; and a digital signature field 705 for storing the digital signature generated by use of the private key 238 (not open to the public) used in the public-key encryption method to prevent falsification of the aforementioned fields.

Although the embodiment has been described on a computer and a removable medium detachable mounted in the computer, the invention may be applied to the case where the computer and the removable medium are replaced by a portable terminal and user data in the portable terminal respectively. In this case, the portable terminal acquires accurate time information by using a portable wireless network when the portable terminal is in a receivable zone, and a timepiece included in the terminal is used when the portable terminal is out of receivable zone.

Although the embodiment has been described on the case where the contents 237 are stored in the removable medium 104, contents stored in the external storage device 207 of the computer 103 may be used as a subject so that the contents are controlled so that writing and browsing can be performed only when a specific removable medium 104 is inserted in the computer 103 but the contents cannot be browsed after the term of validity expires.

As described above, the system for managing the expiration date for use of contents according to this embodiment includes an example of configuration having the following characteristic. First, the executive editor program 206 for generating contents and the executive viewer program 205 for browsing the contents are stored in the memory 203 of the computer 103. Although these programs have been described as the editor program and the viewer program, the invention is not limited thereto. For example, these programs may be integrated into one program which fulfills the two functions.

For editing of contents by use of the executive editor program 206, the contents are encrypted at the point of time when the contents are stored in the removable medium 104. After the contents access limit information in the unforgeable form is added to the encrypted contents so that the contents cannot be forged, the contents are stored in the removable medium. The current time information is acquired from the clock device of the computer or from the NTP server through the network. The last access time information in the unforgeable and user-unreferenced form is written in the removable medium.

For browsing of contents by use of the executive viewer program, the current time information is acquired and the access limit information is confirmed at the point of time when the contents are read from the removable medium. When the acquired current time exceeds the access limit, when there is no access limit information (there is falsification that the access limit was deleted intentionally so as to be absent) or there are signs that the access limit information was forged (the signs of forging are checked on the basis of confirmation of the digital signature with respect to the access limit as shown in the lower half of FIG. 7), when there are signs that the acquired current time was backdated (a5 is before a3 in FIG. 6) or when there are signs that the last access time information was forged or lost (the signs of forging or losing are checked on the basis of confirmation of the digital signature as shown in the upper half of FIG. 7), the user's browsing is denied. Otherwise, the contents are decrypted and the user's browsing is allowed.

The specification and drawings are, accordingly, to be regarded in an illustrative rather than a restrictive sense. It will, however, be evident that various modifications and changes may be made thereto without departing from the spirit and scope of the invention as set forth in the claims.

1. A system for managing an expiration date for use of contents, comprising:
a computer including a CPU, a memory for storing programs inclusive of OS, a clock device, a network I/O module, and a removable media I/O module; and
a removable medium including a memory for storing at least one contents file provided with access limit information, encrypted, written and browsed and last access time information of last access to the contents file, and a controller as a tamper-resistant module, wherein:
current time information is acquired from the clock device; and
illegal access of the contents due to backdating of the clock device is prohibited on the basis of comparison between the acquired current time information and the last access time information stored in the memory of the removable medium.

2. A system for managing an expiration date for use of contents according to claim 1, wherein:
the current time information is also acquired from an NTP server through the network I/O module; and
the contents file is browsed on the basis of the current time information acquired from the NTP server and the access limit information.

3. A system for managing an expiration date for use of contents, comprising:
a computer including a CPU, a memory for storing programs inclusive of OS, a clock device, and a removable media I/O module; and
a removable medium including a memory for storing at least one contents file and last access time information of last access to the contents file, and a controller as a tamper-resistant module, wherein:
a process of editing contents in the removable medium by a editor program stored in the memory of the computer is carried out in such a manner that the contents are encrypted, provided with access limit information and stored in the memory of the removable medium, and current time is acquired from the clock device or from an NTP server through a network and written as the last access time information in the user-unreferenced form in the memory of the removable medium; and
a process of browsing the contents by a viewer program stored in the memory of the computer is carried out in such a manner that current time is acquired from the clock device or from an NTP server through a network, the fact that the acquired current time is unforged is confirmed by comparison between the acquired current time and the last access time on the basis of the acquired current time information, the contents access limit information and the written last access time information, and access to the contents is enabled when the current time is within the access limit.

4. A system for managing an expiration date for use of contents according to claim 1, wherein:
the computer further includes an external storage device connected; and
the editor program and the viewer program are stored in the external storage device and loaded on the memory of the computer so that the contents, the access limit information and the last access time information are written and read.

5. A system for managing an expiration date for use of contents according to claim 1, wherein:
the editor program and the viewer program in addition to the OS are stored in the memory of the computer; and
the viewer program deletes the contents expanded on the memory of the computer when the removable medium is removed from the computer.

6. A system for managing an expiration date for use of contents according to claim 1, wherein:
the computer further includes an external storage device; and
the comparison between the acquired current time information and the last access time information stored in the memory of the removable medium is replaced by comparison between latest date information of the file stored in the external storage device and the acquired current time information.

7. A system for managing an expiration date for use of contents according to claim 1, wherein:
an encryption key is provided in the controller of the removable medium; and
the contents are encrypted by the encryption key while falsification of the access limit information is prevented.

8. A system for managing an expiration date for use of contents, comprising:
a computer including a memory for storing a editor program for generating contents and a viewer program for browsing the contents, a CPU, and a clock device; and
a removable medium including a memory for storing at least one contents file provided with access limit information, encrypted, written and browsed and last access time information of last access to the contents file, wherein:
when the contents are to be stored in the removable medium by the editor program, the contents are encrypted, provided with the access limit information and stored in the removable medium, and current time information is acquired so that the last access time information is written in the memory of the removable medium;
when the contents are to be read from the removable medium by the viewer program, current time information is acquired from the clock device and the access limit information is confirmed so that user's browsing is denied in the case where the acquired current time exceeds the access limit, the access limit information is absent or there are signs that the access limit information was forged, there are signs that the acquired current time was backdated or there are signs that the last access time information was forged or lost, and so that the contents are decrypted and enabled to be browsed by the user in the other case.

9. A method for managing an expiration date for use of contents in a system including:
a computer having a CPU, a memory for storing programs, a clock device, a network I/O module, and a removable media I/O module; and
a removable medium having a memory for storing at least one contents file provided with access limit information, encrypted, written and browsed and last access time information of last access to the contents file, and a controller as a tamper-resistant module,
the method comprising the steps of:
acquiring current time information from the clock device;
comparing the acquired current time information with the last access time information stored in the memory of the removable medium; and
prohibiting illegal browsing of the contents due to backdating of the clock device on the basis of a result of the comparison.

10. A method for managing an expiration date for use of contents in a system including:
a computer having a CPU, a memory for storing programs, a clock device, and a removable media I/O module; and
a removable medium having a memory for storing at least one contents file and last access time information of last access to the contents file, and a controller as a tamper-resistant module, wherein:
a process of writing contents in the removable medium by a editor program stored in the memory of the computer includes the steps of: encrypting the contents, adding access limit information to the encrypted contents and storing the encrypted contents in the memory of the removable medium; and acquiring current time from the clock device or from an NTP server through a network and writing the current time as the last access time information in the user-unreferenced form in the memory of the removable medium; and
a process of browsing the contents by a viewer program stored in the memory of the computer includes the steps of: acquiring current time from the clock device or from an NTP server through a network; confirming the fact that the acquired current time is unforged, by comparison between the acquired current time and the last access time on the basis of the acquired current time information, the contents access limit information and the written last access time information; and enabling access to the contents when the current time is within the access limit.

11. A method for managing an expiration date for use of contents in a system including:
a computer having a memory for storing a editor program for generating contents and a viewer program for browsing the contents, a CPU, and a clock device; and
a removable medium having a memory for storing at least one contents file provided with access limit information, encrypted, written and browsed and last access time information of last access to the contents file, wherein:
a procedure of storing the contents in the removable medium by the editor program includes the steps of: encrypting the contents, adding the access limit information to the encrypted contents and storing the encrypted contents in the removable medium; and acquiring current time information and writing the last access time information in the memory of the removable medium; and
a procedure of reading the contents from the removable medium by the viewer program includes the steps of: acquiring current time information from the clock device; confirming the access limit information; denying user's browsing in the case where the acquired current time exceeds the access limit, the access limit information is absent or there are signs that the access limit information was forged, there are signs that the acquired current time was backdated or there are signs that the last access time information was forged or lost; and decrypting the contents and enabling the contents to be browsed by the user in the other case.

12. A removable medium subjected to management of an expiration date for use of contents, comprising:
a memory for storing at least one contents file written and browsed by a editor program for generating contents and by a viewer program for browsing the contents respectively, and last access time information of last access to the contents file; and
a controller as a tamper-resistant module, wherein:
the contents file is stored in the memory after the contents are encrypted and provided with access limit information in the unforgeable form;
the last access time information of last access to the contents file is stored in the unforgeable and user-unreferenced form in the memory on the basis of current time information acquired from a computer into/from which the removable medium is mounted/removed; and
the last access time information and the access limit information stored in the memory are used as a subject of comparison with the current time information in a process of confirming the fact that the acquired current time information is unforged, by comparison between the current time and the last access time and enabling access to the contents.

13. A program comprising an editor program for generating contents, and a viewer program for browsing the contents, wherein:
the editor program has a function which is used in a process of storing the contents in a removable medium and in which the contents are encrypted, provided with access limit information in the unforgeable form and stored in the removable medium and current time information is acquired and written as last access time information in the unforgeable and user-unreferenced form in the removable medium; and
the viewer program has a function which is used in a process of browsing the contents and in which the acquired current time information is compared with the contents access limit information and the last access time information stored in the removable medium so that access to the contents is enabled when the current time is within the access limit after the fact that the acquired current time information is unforged is confirmed by comparison between the current time information and the last access time information.
